(19) United States
(12) Patent Application Publication
(10) Pub. No.: US 2023/0203219 A1
(43) Pub. Date: Jun. 29, 2023

(54) METHOD OF MANUFACTURING ETHYLENE VINYL ALCOHOL COPOLYMER

(71) Applicant: HANWHA TOTALENERGIES PETROCHEMICAL CO., LTD., Seosan-si (KR)

(72) Inventors: Jung Hun KIM, Seosan-si (KR); Min Su KO, Seosan-si (KR); Sang Joon OH, Seosan-si (KR); Seok Kyoo SEO, Seosan-si (KR); Kwang In KIM, Seosan-si (KR); In Hwa HONG, Seosan-si (KR)

(21) Appl. No.: 18/088,363

(22) Filed: Dec. 23, 2022

(30) Foreign Application Priority Data
Dec. 28, 2021 (KR) 10-2021-0190000

(51) Int. Cl. C08F 216/06

(52) U.S. Cl. CPC C08F 216/06

(57) ABSTRACT

Provided is a method of manufacturing an ethylene vinyl alcohol copolymer, the method including: introducing a monomer including ethylene and vinyl acetate, and a first solvent into a reactor to manufacture an ethylene vinyl acetate copolymer through polymerization; recovering unreacted ethylene after the polymerization; recovering unreacted vinyl acetate after the polymerization; introducing a second solvent different from the first solvent to manufacture an ethylene vinyl alcohol copolymer from the ethylene vinyl acetate copolymer through transesterification; and separating the second solvent-derived acetate produced from the transesterification by the method described herein.

### CROSS-REFERENCE TO RELATED APPLICATIONS

This application claims the benefit of priority to KR Application No. 10-2021-0190000, filed Dec. 28, 2021, which is hereby incorporated by reference in its entirety.

BACKGROUND

### 1. Field

Embodiments relate to a method of manufacturing an ethylene vinyl alcohol copolymer.

### 2. Description of the Related Art

Ethylene vinyl alcohol copolymers have been processed into many different forms such as films, sheets, containers, and fibers, and are used in various applications such as fresh food packaging, and gasoline tanks of vehicles due to their outstanding gas barrier properties, solvent resistance, mechanical strength, and the like.

Typically, industrial methods of manufacturing ethylene vinyl alcohol copolymers include firstly synthesizing ethylene vinyl acetate copolymers through radical solution polymerization using vinyl acetate and ethylene as raw materials, and then hydrolyzing ethylene vinyl acetate copolymers through alkali.

Without a precursor of the ethylene vinyl acetate copolymers, it is hard to directly manufacture the ethylene vinyl alcohol copolymers due to instability of vinyl alcohol monomers. This is why, in general, typical processes use a single solvent of methanol in two consecutive processes of precursor polymerization of ethylene vinyl acetate copolymers and transesterification into ethylene vinyl alcohol copolymers. However, the typical single solvent process of methanol has limitations in controlling molecular weight of ethylene vinyl acetate copolymers as a precursor, and methyl acetate, a by-product produced from the transesterification, has low economic value.

### SUMMARY

An aspect of the present invention provides a method of manufacturing an ethylene vinyl alcohol copolymer capable of separating an acetate-based by-product having high economic value and high purity from a mixture upon manufacturing an ethylene vinyl alcohol copolymer using two different solvents through polymerization and transesterification of the ethylene vinyl acetate copolymer.

According to at least one of embodiments, a method of manufacturing an ethylene vinyl alcohol copolymer includes: introducing a monomer including ethylene and vinyl acetate, and a first solvent into a reactor to manufacture an ethylene vinyl acetate copolymer through polymerization; recovering unreacted ethylene after the polymerization; recovering unreacted vinyl acetate after the polymerization; introducing a second solvent different from the first solvent to manufacture an ethylene vinyl alcohol copolymer from the ethylene vinyl acetate copolymer through transesterification; and separating the second solvent-derived acetate produced from the transesterification, wherein the separating of the second solvent-derived acetate includes: recovering an azeotropic mixture of the second solvent-derived acetate produced from the transesterification, the first solvent, and the second solvent; introducing the azeotropic mixture into a first distillation column to individually separate a first mixture of the first solvent and the second solvent, and a second mixture of the second solvent and the second solvent-derived acetate; introducing the second mixture into a second distillation column having an operating pressure different from that of the first distillation column to separate the second solvent-derived acetate; and recovering a third mixture of the second solvent and the second solvent-derived acetate from the second distillation column.

The third mixture recovered from the second distillation column may be reintroduced into the first distillation column.

The first solvent and the second solvent each may include a C1 to C6 alcohol.

The first solvent may include t-butanol, and the second solvent may include ethanol.

The second distillation column may have a higher operating pressure than the first distillation column.

The first distillation column and the second distillation column may each have an operating pressure of 0.2 bar to 15 bar.

An operating temperature of an upper portion of the first distillation column and an operating temperature of an upper portion of the second distillation column may each be 40° C. to 250° C.

Compared to an azeotropic composition, in the second mixture introduced into the second distillation column, the second solvent may be in a greater content than the second solvent-derived acetate.

An azeotropic composition at the operating pressure of the second distillation column may have a difference of 5 mol % to 25 mol %, compared to an azeotropic composition at the operating pressure of the first distillation column.

A content ratio of the second solvent and the second solvent-derived acetate forming the second mixture may be different from a content ratio of the second solvent and the second solvent-derived acetate forming the third mixture.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain principles of the present disclosure. In the drawings:

FIG. 1 is a process diagram of manufacturing an ethylene vinyl alcohol copolymer according to an embodiment;

FIG. 2 is a process diagram of separating an acetate-based by-product when manufacturing an ethylene vinyl alcohol copolymer according to an embodiment;

FIG. 3 is a process diagram of separating an acetate-based by-product when manufacturing an ethylene vinyl alcohol copolymer according to Example 1; and

FIG. 4 is a process diagram of separating an acetate-based by-product when manufacturing an ethylene vinyl alcohol copolymer according to Comparative Example 1.

### DETAILED DESCRIPTION

Hereinafter, embodiments will be described in detail, and may be readily performed by those who have common knowledge in the related art. However, embodiments may be embodied in many different forms and should not be construed as limited to the embodiments set forth herein.

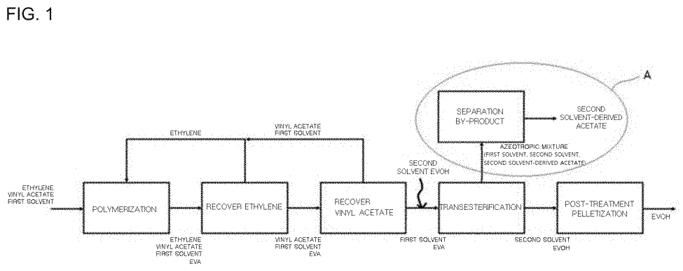

A method of manufacturing an ethylene vinyl alcohol copolymer according to an embodiment will be described with reference to FIG. 1.

FIG. 1 is a process diagram of manufacturing an ethylene vinyl alcohol copolymer according to an embodiment.

Referring to FIG. 1, the ethylene vinyl alcohol copolymer according to an embodiment may largely include polymerization, recovering an unreacted product, transesterification, and separating a by-product.

To be specific, an ethylene vinyl alcohol copolymer may be manufactured by including introducing a monomer including ethylene and vinyl acetate, and a first solvent into a reactor to manufacture an ethylene vinyl acetate copolymer through polymerization; recovering unreacted ethylene after the polymerization; recovering unreacted vinyl acetate after the polymerization; introducing a second solvent different from the first solvent to manufacture an ethylene vinyl alcohol copolymer from the ethylene vinyl acetate copolymer through transesterification; and a process A of separating the acetate-based by-product produced from the transesterification, that is, the second solvent-derived acetate.

In this case, the process A of separating the acetate-based by-product, that is, the second solvent-derived acetate will be described later.

According to an embodiment, after manufacturing an ethylene vinyl acetate (EVA) copolymer, which corresponds to a precursor, through polymerization, an ethylene vinyl alcohol (EVOH) copolymer is manufactured through transesterification. In this case, different solvents are used in the polymerization and transesterification.

Typically, the same methanol solvent was used for both polymerization and transesterification, but in this methanol single solvent process, control over the molecular weight of the ethylene vinyl acetate (EVA) copolymer prepared as a precursor is not easy to obtain a high molecular weight resin, and also methyl acetate produced as a by-product from the transesterification has low economic value and thus is not almost applicable.

On the other hand, according to an embodiment, when different solvents in polymerization and transesterification are used, molecular weight of the ethylene vinyl acetate (EVA) copolymer produced from the polymerization may increase, thereby obtaining a high molecular weight ethylene vinyl alcohol (EVOH) copolymer, and also a by-product produced from the transesterification may be obtained as a material having high economic value. In addition, even when the solvent used in the polymerization for the manufacture of the ethylene vinyl acetate copolymer is not completely separated after the polymerization, the by-product may be separated and secured with high purity from a mixture.

To be specific, the first solvent used in the polymerization may include a C1 to C6 alcohol, and for example, a C1 to C4 alcohol, a C2 to C4 alcohol may be used. As a more specific example, t-butanol may be used as the first solvent.

In addition, the second solvent used in the transesterification may include a C1 to C6 alcohol, and for example, a C1 to C4 alcohol or a C2 to C4 alcohol may be used. As a more specific example, ethanol may be used as the second solvent.

In the polymerization, polymerization of a monomer as a raw material, that is, ethylene and vinyl acetate, and a first solvent as a polymerization solvent is performed to manufacture an ethylene vinyl acetate (EVA) copolymer. The polymerization may be performed through radical solution polymerization.

In this case, the first solvent may be added in an amount of 1 wt % to 30 wt %, for example, 2 wt % to 20 wt %, with respect to a total amount of the monomer and the first solvent. When the first solvent is added in an amount within the above range, an ethylene vinyl acetate (EVA) copolymer containing an optimal amount of ethylene may be obtained.

The ethylene vinyl acetate (EVA) copolymer manufactured through the polymerization may include 20 mol % to 40 mol % ethylene, for example, 25 mol % to 35 mol % ethylene.

The ethylene vinyl acetate (EVA) copolymer manufactured through the polymerization may have a weight average molecular weight of 100,000 g/mol to 400,000 g/mol. When the molecular weight of the ethylene vinyl acetate (EVA) copolymer is within the above range, a high molecular weight applicable not only to the ethylene vinyl alcohol copolymer but also to rubber of the ethylene vinyl acetate copolymer may be obtained to improve physical properties of a product.

Then, recovering an unreacted product after the polymerization is performed. Specifically, recovering unreacted ethylene and recovering unreacted vinyl acetate are sequentially performed, and the recovered monomers may be reintroduced into the polymerization and reused.

Then, the ethylene vinyl acetate (EVA) copolymer manufactured from the polymerization may be converted into an ethylene vinyl alcohol (EVOH) copolymer through transesterification along with a newly added second solvent.

In this case, the second solvent may be added in an amount of 10 wt % to 60 wt %, for example, 15 wt % to 40 wt %, with respect to a total amount of the ethylene vinyl acetate copolymer and the second solvent.

According to an embodiment, different solvents are used in the polymerization and the transesterification, and in this case, even when the first solvent used in the polymerization is not completely removed after the polymerization, according to an embodiment, an acetate-based by-product may be separated from a mixture of the first solvent, the second solvent, and the acetate-based by-product, with high purity.

Then, the second solvent may be removed through post-treatment or pelletization to obtain an ethylene vinyl alcohol (EVOH) copolymer.

According to an embodiment, after the transesterification, the ethylene vinyl alcohol (EVOH) copolymer as well as the acetate-based by-product produced together may be separated with high purity.

The acetate-based by-product may be an alkyl acetate having an alkyl group derived from the second solvent used in the transesterification. For example, when ethanol is used as the second solvent, the obtained acetate-based by-product may be ethyl acetate.

The obtained acetate-based by-product may be highly useful as a material having high economic value.

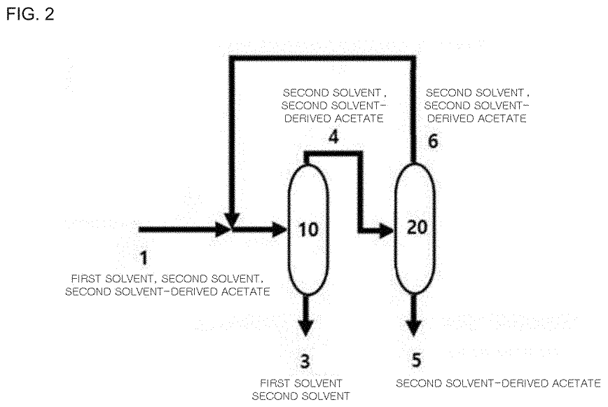

The process of separating the acetate-based by-product will be described with reference to FIG. 2.

FIG. 2 is a process diagram of separating an acetate-based by-product when manufacturing an ethylene vinyl alcohol copolymer according to an embodiment.

Referring to FIG. 2, the separating of the acetate-based by-product, that is, the second solvent-derived acetate, may include recovering an azeotropic mixture of the second solvent-derived acetate produced from the transesterification, the first solvent, and the second solvent; introducing the azeotropic mixture 1 into a first distillation column 10 to individually separate a first mixture 3 of the first solvent and the second solvent, and a second mixture 4 of the second solvent and the second solvent-derived acetate; introducing the second mixture 4 into a second distillation column 20 having an operating pressure different from that of the first distillation column 10 to separate a second solvent-derived acetate 5; and recovering a third mixture 6 of the second solvent and the second solvent-derived acetate from the second distillation column 20.

In addition, the third mixture 6 recovered from the second distillation column 20 may be introduced into the first distillation column 10 and reused.

According to an embodiment, the second solvent-derived acetate is separated from a mixture formed of the second solvent-derived acetate, the first solvent, and the second solvent by sequentially using two distillation columns having different pressures, the second solvent-derived acetate may be separated and secured with high purity.

Specifically, when the azeotropic mixture 1 is introduced into the first distillation column 10, the azeotropic mixture 1 may be mixed with the third mixture 6 from an upper portion of the second distillation column 20 and be introduced into the first distillation column 10 together.

The first mixture 3 of the first solvent and the second solvent may be separated from a lower portion of the first distillation column 10 according to composition ratio of the azeotropic mixture 1 and operating pressure conditions of the first distillation column 10.

In the upper portion of the first distillation column 10, the second mixture 4 of the second solvent and the second solvent-derived acetate is separated, and in this case, the second mixture 4 may be separated in a composition close to an azeotropic composition at the operating pressure of the second distillation column 20, thus being introduced into the second distillation column 20.

The second mixture 4 introduced into the second distillation column 20 is separated, and a pure second solvent-derived acetate 5 is recovered from the lower portion of the second distillation column 20, and a third mixture 6 of the second solvent and the second solvent-derived acetate is recovered from an upper portion of the second distillation column 20. In this case, the third mixture 6 may be recovered in a composition close to an azeotropic composition corresponding to the operating pressure of the second distillation column 20. The third mixture 6 may be reintroduced into the first distillation column 10.

In this case, the azeotropic composition at the operating pressure of the second distillation column 20 may have a difference of 5 mol % to 35 mol %, compared to an azeotropic composition at the operating pressure of the first distillation column 10, and for example, the difference may be at least 15 mole % to 25 mole %. When the azeotropic composition of the first distillation column and the second distillation column have a difference within the above range, the second solvent-derived acetate, which is an acetate-based by-product, may be separated and secured with high purity.

The first distillation column 10 may have an operating pressure of 0.2 bar to 15 bar, for example, 0.3 bar to 3 bar. In addition, the second distillation column 20 may have an operating pressure of 0.2 bar to 15 bar, for example, 2 bar to 10 bar. In this case, the operating pressure of the second distillation column 20 may be higher than the operating pressure of the first distillation column 10. When the operating pressures of the first distillation column and the second distillation column are within the above ranges, the second solvent-derived acetate, which is an acetate-based by-product, may be separated and secured with high purity.

The first distillation column 10 may have an operating temperature of 40° C. to 250° C., for example, 40° C. to 110° C., 40° C. to 60° C. in the upper portion thereof. In addition, the second distillation column 20 may have an operating temperature of 40° C. to 250° C., for example, 40° C. to 110° C., 40° C. to 60° C. in the upper portion thereof. When the operating temperatures of the upper portion of the first distillation column and the second distillation column are each within the above ranges, the second solvent-derived acetate, which is an acetate-based by-product, may be separated and secured with high purity.

Compared to the azeotropic composition, in the second mixture 4 introduced into the second distillation column 20, that is, the second mixture formed of the second solvent and the second solvent-derived acetate, the second solvent may be in a greater content than the second solvent-derived acetate. When the second mixture has the above composition, the second solvent-derived acetate, which is an acetate-based by-product, may be separated and secured with high purity.

A content ratio of the second solvent and the second solvent-derived acetate forming the second mixture 4 may be different from a content ratio of the second solvent and the second solvent-derived acetate forming the third mixture 6. Specifically, a content weight ratio of the second solvent and the second solvent-derived acetate forming the second mixture 4 may be 15:85 to 50:50, for example, 20:80 to 40:60. In addition, a content weight ratio of the second solvent and the second solvent-derived acetate forming the third mixture 6 may be 40:60 to 90:10, for example, 50:50 to 70:30. When the composition of the second mixture and the composition of the third mixture are different as described above, the second solvent-derived acetate, which is an acetate-based by-product, may be separated and secured with high purity.

Hereinafter, specific examples of the present disclosure are presented. However, the following examples are merely used to illustrate or describe the present disclosure in more detail, and are not to be seen as limiting the present disclosure. Furthermore, what is not described herein may be sufficiently understood by those skilled in the art who have knowledge in this field, and thus be omitted.

### Manufacture of Ethylene Vinyl Alcohol Copolymer

### Example 1

11 wt % ethylene, 63 wt % of vinyl acetate, and 26 wt % of t-butanol as a first solvent were put into a reactor to perform polymerization under the conditions of 55° C. and 38 kg/cm²g so as to manufacture an ethylene vinyl acetate (EVA) copolymer containing 30 mol % of ethylene.

Then, unreacted ethylene and unreacted vinyl acetate were sequentially recovered.

Thereafter, 20 wt % of the manufactured ethylene vinyl acetate (EVA) copolymer, 40 wt % of unreacted first solvent t-butanol, and 40 wt % of ethanol as a second solvent were added to perform transesterification under the conditions of 3 bar and 110° C. so as to manufacture an ethylene vinyl alcohol (EVOH) copolymer, and in this case, ethyl acetate was also produced together as a by-product.

At a lower end of the reactor, a mixture of the manufactured ethylene vinyl alcohol (EVOH) copolymer and the second solvent, ethanol, was recovered, and then an ethylene vinyl alcohol (EVOH) copolymer from which the second solvent was removed through post-treatment and pelletization was secured.

In addition, at an upper end of the reactor, an azeotropic mixture of t-butanol as a first solvent, ethanol as a second solvent, and ethyl acetate produced as a by-product was recovered.

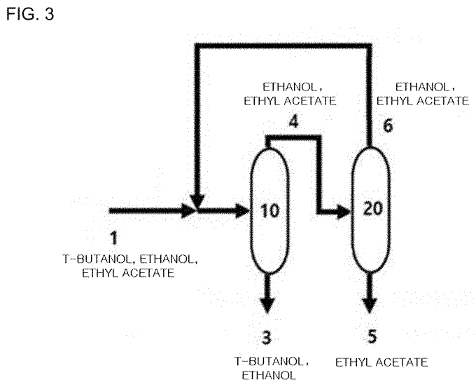

A method of separating ethyl acetate from the azeotropic mixture is the same as in FIG. 3.

FIG. 3 is a process diagram of separating an acetate-based by-product when manufacturing an ethylene vinyl alcohol copolymer according to Example 1.

Referring to FIG. 3, an azeotropic mixture 1 of t-butanol, ethanol, and ethyl acetate was put into a first distillation column 10 having an operating pressure of 0.4 bar, an operating temperature of 48° C. at an upper portion of the column, and an operating temperature of 59° C. at a lower portion of the column, and in this case, the mixture was mixed with a third mixture 6 of ethanol and ethyl acetate from the upper portion of a second distillation column 20, and put into the first distillation column 10. A first mixture 3 of t-butanol and ethanol was recovered from the lower portion of the first distillation column 10, and a second mixture 4 of 26.8 wt % of ethanol and 73.2 wt % of ethyl acetate was recovered from the upper portion of the first distillation column 10. Then, the second mixture 4 was put into the second distillation column 20 having an operating pressure of 3.1 bar, an operating temperature of 106° C. at the upper portion of the column, and an operating temperature of 116° C. at the lower portion of the column, 99.9 wt % of ethyl acetate 5 was recovered from the lower portion of the second distillation column 20, and a third mixture 6 of 39.4 wt % of ethanol and 60.5 wt % of ethyl acetate was recovered from the upper portion of the second distillation column 20. The third mixture 6 was again put into the first distillation column (10) and reused.

### Comparative Example 1

An ethylene vinyl alcohol (EVOH) copolymer was obtained in the same manner as in Example 1, except for the method of separating ethyl acetate from an azeotropic mixture in Example 1.

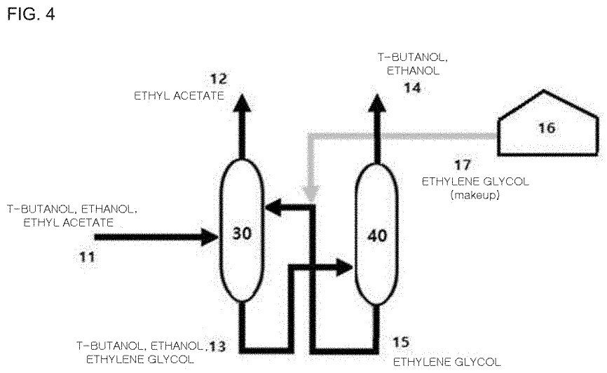

In this case, a method of separating ethyl acetate is the same as in FIG. 4.

FIG. 4 is a process diagram of separating an acetate-based by-product when manufacturing an ethylene vinyl alcohol copolymer according to Comparative Example 1.

Referring to FIG. 4, a mixture 11 of t-butanol, ethanol, and ethyl acetate was put into a first distillation column 30, and in this case, the mixture was mixed with ethylene glycol 15 recovered from a second distillation column 40. Since ethylene glycol is a material having relatively better affinity with t-butanol and ethanol than ethyl acetate, 99.5 wt % or more of ethyl acetate 12 was recovered to the upper portion of the first distillation column 30. The remaining first mixture 13 of t-butanol, ethanol, and ethylene glycol was recovered to the lower portion of the first distillation column 30 and put into the second distillation column 40. In the second distillation column 40, a second mixture 14 of t-butanol and ethanol, and ethylene glycol 15 were separated, and the separated ethylene glycol 15 was again put into the first distillation column 30 after makeup (17) was performed on a portion of the separated ethylene glycol 15 in a storage 16.

Referring to Example 1 and Comparative Example 1, compared with the case of Comparative Example 1 in which a mixture was separated using an extractive distillation method with ethylene glycol, in the case of Example 1 in which a mixture was separated using two distillation columns having different operating pressures according to an embodiment, highly pure ethyl acetate may be separated and secured, controlling the purity of a product is easier, working environment is good with no need of using an extractant or azeotropic agent that adversely affects the working environment, and utility costs in the processes are lower.

On the other hand, Comparative Example 1 has limitations in securing product purity due to an extractant, and has a risk that water, which is a major impurity of a product, is concentrated during purification.

According to an embodiment, upon manufacturing an ethylene vinyl alcohol copolymer using two different solvents through polymerization and transesterification of the ethylene vinyl acetate copolymer, even when a solvent used in the polymerization of the ethylene vinyl acetate copolymer is not completely separated after the polymerization, an acetate-based by-product having high economic value and high purity may be separated and secured from the mixture.

Although preferred embodiments of the present invention have been described above, the present invention is not limited thereto and may be embodied by being modified in various ways within the scope of the claims, the detailed description, and the accompanying drawings. Such modifications belong to the scope of the present invention.

What is claimed is:

1. A method of manufacturing an ethylene vinyl alcohol copolymer, the method comprising:
introducing a monomer including ethylene and vinyl acetate, and a first solvent into a reactor to manufacture an ethylene vinyl acetate copolymer through polymerization;
recovering unreacted ethylene after the polymerization;
recovering unreacted vinyl acetate after the polymerization;
introducing a second solvent different from the first solvent to manufacture an ethylene vinyl alcohol copolymer from the ethylene vinyl acetate copolymer through transesterification; and
separating a second solvent-derived acetate produced from the transesterification,
wherein the separating of the second solvent-derived acetate includes:
recovering an azeotropic mixture of the second solvent-derived acetate produced from the transesterification, the first solvent, and the second solvent;
introducing the azeotropic mixture into a first distillation column to individually separate a first mixture of the first solvent and the second solvent, and a second mixture of the second solvent and the second solvent-derived acetate;
introducing the second mixture into a second distillation column having an operating pressure different from that of the first distillation column to separate the second solvent-derived acetate; and
recovering a third mixture of the second solvent and the second solvent-derived acetate from the second distillation column.

2. The method of claim 1, wherein the third mixture recovered from the second distillation column is reintroduced into the first distillation column.

3. The method of claim 1, wherein the first solvent and the second solvent each comprise a C1 to C6 alcohol.

4. The method of claim 1, wherein the first solvent comprises t-butanol, and
the second solvent comprises ethanol.

5. The method of claim 1, wherein the second distillation column has a higher operating pressure than the first distillation column.

6. The method of claim 1, wherein the first distillation column and the second distillation column each have an operating pressure of 0.2 bar to 15 bar.

7. The method of claim 1, wherein an operating temperature of an upper portion of the first distillation column and an operating temperature of an upper portion of the second distillation column are each 40° C. to 250° C.

8. The method of claim 1, wherein compared to an azeotropic composition, in the second mixture introduced into the second distillation column, the second solvent is in a greater content than the second solvent-derived acetate.

9. The method of claim 1, wherein an azeotropic composition at the operating pressure of the second distillation column has a difference of 5 mol % to 25 mol %, compared to an azeotropic composition at the operating pressure of the first distillation column.

10. The method of claim 1, wherein a content ratio of the second solvent and the second solvent-derived acetate forming the second mixture is different from a content ratio of the second solvent and the second solvent-derived acetate forming the third mixture.
